(19) United States
(12) Patent Application Publication
(10) Pub. No.: US 2022/0098531 A1
(43) Pub. Date: Mar. 31, 2022

(54) Soap Molder

(71) Applicant: Percy Lee Anderson, New York, NY (US)

(72) Inventor: Percy Lee Anderson, New York, NY (US)

(21) Appl. No.: 17/300,421

(22) Filed: Jun. 28, 2021

Related U.S. Application Data
(60) Provisional application No. 63/204,384, filed on Sep. 29, 2020.

(51) Int. Cl. C11D 13/16

(52) U.S. Cl. CPC C11D 13/16

(57) ABSTRACT

A soap remnant molding assembly includes a squeezer having a housing portion defining a chamber, and a handle portion engaged to the housing portion and extending outwardly from the housing portion. The molding assembly also includes a squeezer cover pivotally coupled to the squeezer and adapted to move between an open position and a close position. The squeezer cover includes a cover portion adapted to engaged with the housing portion and cover an access opening of the chamber in the close position of the squeezer cover, and a handle structure extending from the cover portion. A tray is removably arranged inside the chamber and includes a cavity to receive a plurality of soap remnants. The plurality of soap remnants arranged inside the cavity are pressed together to form a soap bar in response to the pivoting of the squeezer cover to the close position.

### TECHNICAL FIELD

The present disclosure relates, generally, to a molding assembly. More particularly, the present disclosure relates to a molding assembly suitable for reforming small soap remnants into a soap bar.

### BACKGROUND

Soap bars, as originally made and sold, are sized to be held in one's hand; but use of a bar with water reduces its size eventually to something too small and/or too pliable for gripping when wet and slippery. Waste is common then, with such small pieces of soap bar frequently being thrown away or being washed down the drain.

### SUMMARY

According to an aspect of the disclosure a soap remnant molding assembly is disclosed. The soap remnant molding assembly includes a squeezer, a squeezer cover, and a tray. The squeezer includes a housing portion defining a chamber and having an edge defining an access opening of the chamber. The squeezer also includes a handle portion engaged to the housing portion and extending outwardly from the housing portion. Further, the squeezer cover is pivotally coupled to the squeezer and is adapted to move between an open position and a close position. The squeezer cover includes a cover portion adapted to engaged with the housing portion and covers the access opening in the close position of the squeezer cover. Moreover, the squeezer cover includes a handle structure extending from the cover portion and adapted to engage with the handle portion. The tray is removably arranged inside the chamber and includes a cavity to receive a plurality of soap remnants. The plurality of soap remnants arranged inside the cavity are pressed together to form a soap bar when the squeezer cover is moved to the close position.

In one embodiment, the squeezer cover includes a fork structure having a pair of forks arranged spaced apart and extending outwardly from the cover portion and the squeezer includes an eye structure extending from the housing portion and arranged opposite to the handle portion. The eye structure is arranged between the pair of the forks.

In one embodiment, a pin extends through the eye structure and the pair of forks and pivotally couples the squeezer cover to the squeezer. The squeezer cover pivots about a longitudinal axis of the pin.

In one embodiment, the housing portion includes a hollow semi-spherical structure, and the cover portion includes a circular disk structure.

In an embodiment, the tray includes an outer surface adapted to abut an inner surface of the housing portion and an inner surface defining the cavity.

In an embodiment, the cavity is a rectangular cavity.

In an embodiment, the handle portion includes an elongated groove, and the handle structure includes an elongated protrusion adapted to be arranged inside the elongated groove in the close position of the squeezer cover.

In an embodiment, the tray includes a skirt portion extending radially outwardly of an upper edge of a wall of the tray. The skirt portion is arranged outside the housing portion abutting the edge of the housing portion when the tray is arranged inside the chamber.

Additional aspects and advantages will be apparent from the following detailed description of example embodiments, which proceeds with reference to the accompanying drawings.

### BRIEF DESCRIPTION OF THE DRAWINGS

FIG. 1 illustrates a front perspective view of a soap remnants molding assembly, in accordance with an embodiment of the disclosure;

FIG. 2 illustrates an exploded view of the soap remnant molding assembly of FIG. 1, in accordance with an embodiment of the disclosure; and

FIG. 3 illustrates a rear perspective view of a squeezer cover of the soap remnant molding assembly of FIG. 2, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc., mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

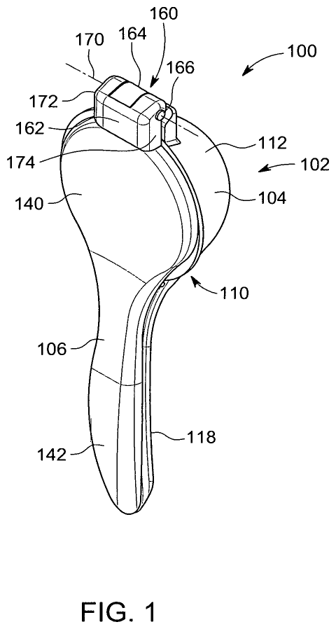

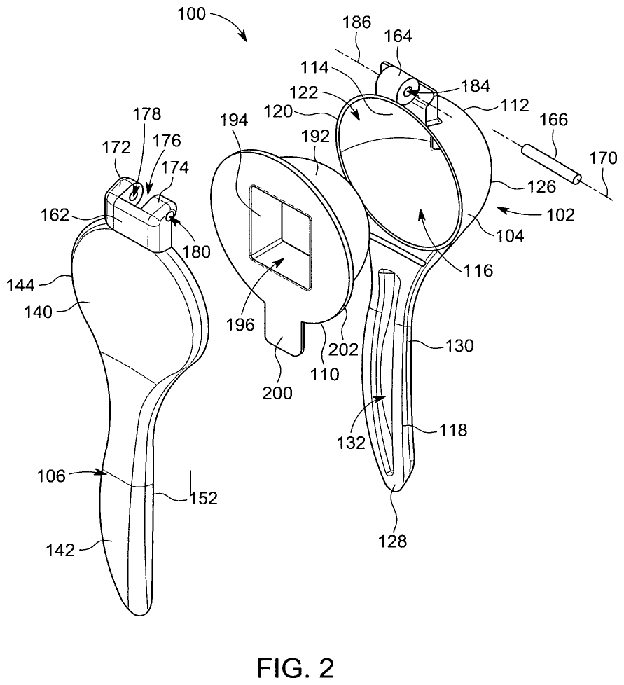

Referring to FIGS. 1 and 2, a soap remnant molding assembly 100 (hereinafter referred to as a molding assembly 100) suitable for reforming a plurality of soap remnants into a soap bar, according to an example embodiment is shown. The molding assembly 100 includes a squeezer assembly 102 having a squeezer 104 and a squeezer cover 106 pivotally attached to the squeezer 104 and adapted to pivot/move between an open position and a close position, and a tray 110 adapted to be removably arranged inside the squeezer 104 and hold the plurality of soap remnants.

As best shown in FIG. 2, the squeezer 104 includes a housing portion 112 having an inner surface 114 defining a chamber 116 to receive the tray 110 and a handle portion 118 to facilitate a holding of the squeezer 104. The handle portion 118 extends outwardly from the housing portion 112 and is an elongated structure. As shown, the handle portion 118 is connected to the housing portion 112 at a location proximate to an upper edge 120 of the housing portion 112. The upper edge 120 defines an access opening 122 of the chamber 116 and may extend circularly around a central axis of the housing portion 112. As shown, the housing portion 112 is contemplated as a hollow semi spherical structure, however, the housing portion 112 may include any other shape or structure generally known in the art.

Also, the handle portion 118 extends radially outwardly from an outer surface 126 of the housing portion 112 and includes a first surface 128 (i.e., upper surface) and a second surface 130 (i.e., lower surface 130) arranged opposite to the first surface 128. In an embodiment, the first surface 128 defines an elongated groove 132 extending in a longitudinal direction along at least a portion of the length of the handle portion 118. The groove 132 may be a blind groove that extends inside the handle portion 118 from the first surface 128 towards the second surface 130. The groove 132 is adapted to receive a complimentary structure of the squeezer cover 106 in the close position of the squeezer cover 106. It may be appreciated that the handle portion 118 is a substantially flat plate type structure having a length greater than a width of the handle portion 118.

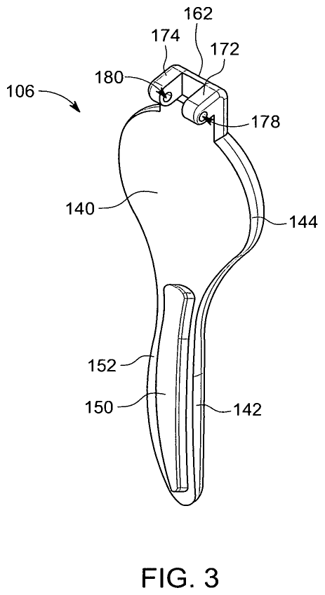

The squeezer cover 106 includes a cover portion 140 having a substantially disk-shaped structure and a handle structure 142 extending radially outwardly from an outer edge 144 of the cover portion 140. In the close position of the squeezer cover 106, the cover portion 140 is adapted to cover or close the access opening 122 of the housing portion 112 and rests on the upper edge 120 of the housing portion, while the handle structure 142 is adapted to align and engage with the handle portion 118. Further, in the open position of the squeezer cover 106, the cover portion 140 and the handle structure 142 are respectively arranged away from the housing portion 112 and the handle portion 118, providing an access of the chamber 116 of the housing portion 112 through the access opening 122. Additionally, as shown in FIG. 3, the handle structure 142 may include an elongated protrusion 150 extending in a longitudinal direction along a length of the handle structure 142. The protrusion 150 extends outwardly from a first surface 152 of handle structure 142 and is arranged substantially perpendicularly to the first surface 152 of the handle structure 142. As with the handle portion 118, the handle structure 142 includes a length greater than a width of the handle structure 142. It may be appreciated that a user may hold the handle portion 118 and the handle structure 142 to pivot the squeezer cover 106 towards the close position to apply pressure on the soap remnants arranged inside the tray 110 to reform the soap remnants into the soap bar.

To facilitate the pivotal engagement of the squeezer cover 106 with the squeezer 104, the squeezer assembly 102 includes a hinge assembly 160 having a fork structure 162 integrally formed with the cover portion 140, an eye structure 164 integrally formed with the housing portion 112, and a pin 166 extending through the fork structure 162 and the eye structure 164. The hinge assembly 160 pivotally coupling the squeezer cover 106 with the squeezer 104 such that the squeezer cover 106 is adapted to pivot about a longitudinal central axis 170 of the pin 166. As shown, the fork structure 162 includes a pair of forks 172, 174 extending outwardly from the cover portion 140 and arranged opposite to the handle structure 142. Accordingly, the forks 172, 174 extend from the outer edge 144 of the cover portion 140 in a direction opposite to that of the handle structure 142. Moreover, forks 172, 174 are disposed spaced apart and substantially parallel to each other, defining a gap 176 therebetween to receive the eye structure 164. Additionally, to facilitate an extension of the pin 166 through the fork structure 162, the pair of forks 172, 174 defines a pair of aligned holes 178, 180 such that central axes of the holes 178, 180 aligned with each other and are arranged substantially perpendicularly to a central longitudinal axis of the handle structure 142.

The eye structure 164 extends radially outwardly from the outer surface 126 of the housing portion 112 and is arranged diametrically opposite to the handle portion 118. In an embodiment, the eye structure 164 includes a substantially hollow cylindrical structure defining a lateral hole 184 having a central axis 186 arranged substantially perpendicular to a central longitudinal axis of the handle portion 118. In an assembly of the squeezer cover 106 with the squeezer 104, the eye structure 164 is arranged inside the gap 176 defined between the forks 172, 174 such that the central axes of the holes 178, 180 are in alignment with the central axis 186 of the lateral hole 184. Further, in the assembly, the pin 166 extends through the lateral hole 184 and holes 178, 180, thereby pivotally coupling the squeezer cover 106 to the squeezer 104.

Referring to FIG. 2, the tray 110 includes a wall 190 having an outer surface 192 adapted to abut the inner surface 114 of the housing portion 112 and an inner surface 194 defining a cavity 196 to receive the plurality of soap remnants for reforming the soap remnants into the soap bar. As shown, the outer surface 192 includes a shape complimentary to a shape of inner surface 114 of the housing portion 112, while the inner surface 194 defining the cavity 196 may include any shape corresponding to a desired shape of the soap bar. In the illustrated embodiment, the outer surface 192 includes a semispherical shape, while the inner surface 194 and the cavity 196 may include a half cuboidal shape. In an embodiment, the cavity 196 may be a rectangular cavity. Additionally, the tray 110 may include a skirt portion 200 extending outwardly from an upper edge 202 of the wall 190 of the tray 110 and adapted to be disposed outside the housing portion 112 when the tray 110 is arranged inside the housing portion 112. The skirt portion 200 facilitates a holding of the tray 110 and a removal of the tray 110 from the housing portion 112. As shown in FIG. 1, in an arrangement of the tray 110 inside the housing portion 112, the skirt portion 200 abuts and rests on the upper edge 120 of the housing portion 112.

A method for reforming the plurality of soap remnants into the soap bar using the molding assembly 100 is now described. For reforming the soap remnants into the soap bar, a user may soak the soap remnant into a hot water to make the soap remnants pliable. After soaking the soap remnants or otherwise, the user may insert the soap remnants inside the cavity 196 of the tray 110. In an embodiment, the user may arrange/position enough soap remnants inside the cavity 196 such that the cavity 196 is completely filled with the soap remnants and a few soap remnants may extend outside the cavity 196. Thereafter, the user may position/arranged the tray 110 inside the chamber 116 of the housing portion 112 such that the skirt portion 200 of the tray 110 extends outside the chamber 116. In an embodiment, the user may fill the cavity 196 of the tray 110 with the soap remnants after positioning the tray 110 inside the chamber 116 of the housing portion 112.

Subsequently, the user may hold the handle structure 142 of the squeezer cover 106 and move/pivot the squeezer cover 106 towards the close position. The user may hold both the handle structure 142 and the handle portion 118 and applies pressure to move the handle structure 142 towards the handle portion 118 to arrange the squeezer cover 106 in the close position. In so doing, the protrusion 150 may extend inside the groove 132 of the handle portion 118. Due to the application of the pressure and the movement of the squeezer cover 106 to the close position, the cover portion 140 applies pressure on the soap remnants and reforms the soap remnants into the soap bar. In an embodiment, the molding assembly 100 is submerged into a hot water while keeping the squeezer cover 106 in the close position to facilitate the reformation of the plurality of soap remnants into the soap bar. After formation of the soap bar, the user may remove the soap bar from the tray 110 by moving the squeezer cover 106 to the open position. In this manner, the molding assembly 100 facilitates conversion of the soap remnants into the soap bar in an inexpensive and easy way, and prevents the wastage.

### LIST OF ELEMENTS

100 molding assembly
102 Squeezer assembly
104 squeezer
106 squeezer cover
110 tray
112 housing portion
114 inner surface
116 chamber
120 upper edge
122 access opening
126 outer surface
128 first surface
130 second surface
132 groove
140 cover portion
142 handle structure
144 outer edge
150 protrusion
152 first surface
160 hinge assembly
162 fork structure
164 eye structure
166 pin
170 longitudinal central axis
172 fork
174 fork
176 gap
178 hole
180 hole
184 lateral hole
186 central axis
190 wall
192 outer surface
194 inner surface
196 cavity
200 skirt portion
202 upper edge

What is claimed is:

1. A soap remnant molding assembly, comprising:
a squeezer having
a housing portion defining a chamber and having an edge defining an access opening of the chamber, and
a handle portion engaged to the housing portion and extending outwardly from the housing portion;
a squeezer cover pivotally coupled to the squeezer and adapted to move between an open position and a close position, the squeezer cover includes
a cover portion adapted to engaged with the housing portion and cover the access opening in the close position of the squeezer cover, and
a handle structure extending from the cover portion and adapted to engage with the handle portion; and
a tray removably arranged inside the chamber and including a cavity to receive a plurality of soap remnants, wherein the plurality of soap remnants arranged inside the cavity are pressed together to form a soap bar when the squeezer cover is moved to the close position.

2. The soap remnant molding assembly of claim 1, wherein
the squeezer cover includes a fork structure having a pair of forks arranged spaced apart and extending outwardly from the cover portion,
the squeezer includes an eye structure extending from the housing portion and arranged opposite to the handle portion, the eye structure being arranged between the pair of the forks, and
a pin extends through the eye structure and the pair of forks and pivotally couples the squeezer cover to the squeezer, wherein the squeezer cover pivots about a longitudinal axis of the pin.

3. The soap remnant molding assembly of claim 1, wherein the housing portion includes a hollow semi-spherical structure, and the cover portion includes a circular disk structure.

4. The soap remnant molding assembly of claim 1, wherein the tray includes an outer surface adapted to abut an inner surface of the housing portion and an inner surface defining the cavity.

5. The soap remnant molding assembly of claim 4, wherein the cavity is a rectangular cavity.

6. The soap remnant molding assembly of claim 1, wherein
the handle portion includes an elongated groove, and
the handle structure includes an elongated protrusion adapted to be arranged inside the elongated groove in the close position of the squeezer cover.

7. The soap remnant molding assembly of claim 1, wherein the tray includes a skirt portion extending radially outwardly of an upper edge of a wall of the tray, wherein the skirt portion is arranged outside the housing portion abutting the edge of the housing portion when the tray is arranged inside the chamber.
